(19) United States
(12) Patent Application Publication
(10) Pub. No.: US 2016/0365544 A1
(43) Pub. Date: Dec. 15, 2016

(54) SECONDARY BATTERY

(71) Applicant: SAMSUNG SDI CO., LTD., Yongin-si (KR)

(72) Inventors: Seokbong LEE, Yongin-si (KR); Bohyun BYUN, Yongin-si (KR)

(21) Appl. No.: 14/956,418

(22) Filed: Dec. 2, 2015

(30) Foreign Application Priority Data
Jun. 12, 2015 (KR) 10-2015-0083399

(51) Int. Cl. H01M 2/02; H01M 10/04

(52) U.S. Cl. CPC H01M 2/0217; H01M 10/0431; H01M 2/0212; H01M 2/021

(57) ABSTRACT

A secondary battery configured to be bendable at an angle required in a device is provided. The secondary battery includes a pouch including a first external case and a second external case, a plurality of electrode assemblies accommodated in the pouch, and lead tabs electrically connected to each other while passing through the plurality of electrode assemblies.

### CROSS-REFERENCE TO RELATED APPLICATION

Korean Patent Application No. 10-2015-0083399, filed on Jun. 12, 2015, in the Korean Intellectual Property Office, and entitled: “Secondary Battery,” is incorporated by reference herein in its entirety.

### BACKGROUND

1. Field

Embodiments relate to a secondary battery that is bendable.

2. Description of the Related Art

Secondary batteries are chargeable and dischargeable. Examples of secondary batteries include nickel (Ni)-cadmium (Cd) batteries, Ni-hydrogen (H) batteries, and lithium (Li) batteries. For example, a lithium (Li) secondary battery may have an operation voltage of about 3.6V, which is about three times higher than that of the nickel (Ni) battery widely used as a power source for an electronic device. In addition, the lithium (Li) battery may have a high energy density per unit weight.

The lithium (Li) battery may be classified as a liquid electrolyte battery and a polymer electrolyte battery according to the kind of electrolyte used. In general, a battery using a liquid electrolyte is referred to as a lithium ion battery and a battery using a polymer electrolyte is referred to as a lithium polymer battery.

The lithium (Li) battery may be manufactured in various types, including, for example, a cylindrical type and a prismatic type, which are typically used in the lithium ion battery, and a pouch type, which is typically used in the lithium polymer battery.

### SUMMARY

Embodiments are directed to a secondary battery including a pouch including a first external case and a second external case, a plurality of electrode assemblies accommodated in the pouch, and lead tabs electrically connected to each other, the lead tabs passing through each of the plurality of electrode assemblies.

The lead tabs may be integrally formed and wound together with the plurality of electrode assemblies.

Grooves may be located on a surface of one selected from the first external case and the second external case.

The grooves may be provided at positions corresponding to exposed portions of the lead tabs between the plurality of electrode assemblies.

The grooves may extend across the surface of the one selected from the first external case and the second external case in a second direction perpendicular to a first direction in which the electrode assemblies are arranged.

One or more notches may be formed at regions corresponding to opposite ends of each of the grooves. The notches may extend in an inward direction.

The first external case and the second external case may be fused at edges of the pouch. The one or more notches may extend horizontally in the inward direction from edges of the pouch at which the first external case and the second external case are fused.

The first external case and the second external case of the pouch may include first grooves and second grooves respectively provided on surfaces of the first external case and the second external case. The second grooves may be larger than the first grooves.

The first grooves and the second grooves protrude toward the inside of the pouch so as to contact the lead tabs.

The first grooves and the second grooves may be formed at vertically corresponding positions.

### BRIEF DESCRIPTION OF THE DRAWINGS

Features will become apparent to those of skill in the art by describing in detail exemplary embodiments with reference to the attached drawings in which:

FIG. 1 illustrates a perspective view of a secondary battery according to an embodiment;

FIG. 2 illustrates an exploded perspective view of the secondary battery depicted in FIG. 1;

FIG. 3 illustrates a cross-sectional view taken along the line A-A′ of FIG. 1;

FIG. 4 illustrates a cross-sectional view depicting a state in which the secondary battery depicted in FIG. 1 is bent;

FIG. 5 illustrates a perspective view of a secondary battery according to another embodiment;

FIG. 6 illustrates a perspective view of a secondary battery according to another embodiment; and

FIG. 7 illustrates a cross-sectional view taken along the line B-B′ of FIG. 6.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “between” two layers, it can be the only layer between the two layers, or one or more intervening layers may also be present. Like reference numerals refer to like elements throughout.

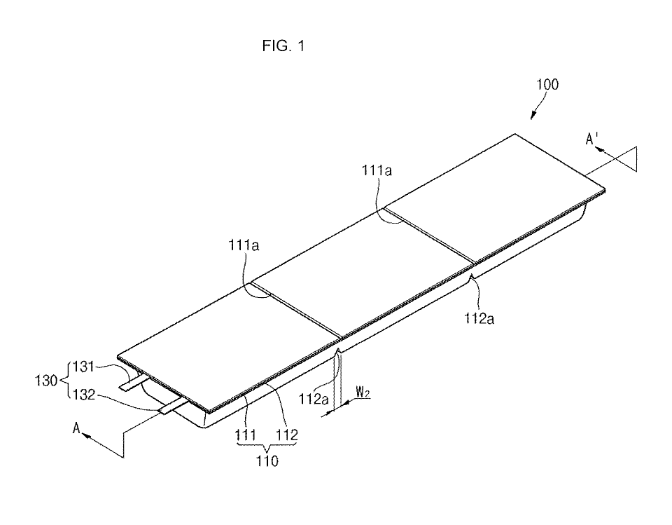

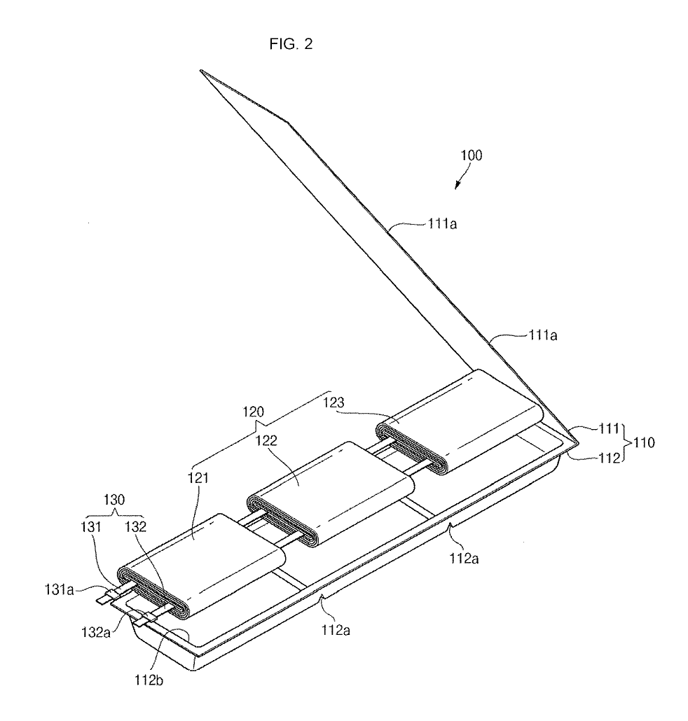

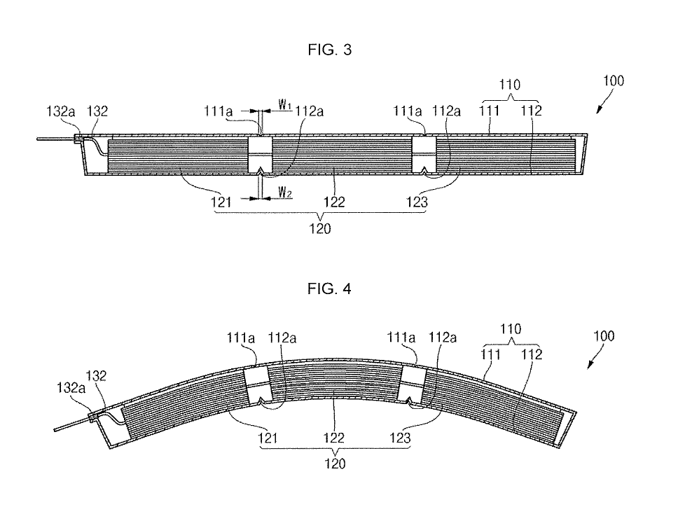

FIG. 1 illustrates a perspective view of a secondary battery according to an embodiment, FIG. 2 illustrates an exploded perspective view of the secondary battery illustrated in FIG. 1, FIG. 3 illustrates a cross-sectional view taken along the line A-A′ of FIG. 1, and FIG. 4 illustrates a cross-sectional view depicting a state in which the secondary battery illustrated in FIG. 1 is bent.

Referring to FIGS. 1 to 4, the secondary battery 100 according to an embodiment includes a pouch 110, a plurality of electrode assemblies 120 mounted in the pouch 110, and lead tabs 130 connecting the electrode assemblies 120 as a whole, the lead tabs being exposed to the outside of the pouch 110.

The pouch 110 may be formed as a multi-layered sheet structure. For example, the pouch 110 may include a polymer sheet forming its inner surface and providing insulation and thermal fusion, a polyethyleneterephthalate (PET) sheet, a nylon sheet or a PET-nylon complex sheet (to be referred to as a “nylon sheet” for brevity) forming the outer surface of the pouch 110 and providing protection, and a metal sheet providing mechanical strength. The metal sheet may be interposed between the polymer sheet and the nylon sheet and may be, for example, an aluminum sheet.

The pouch 110 may include a first external case 111 provided as a substantially planar plate and a second external case 112 having an open top portion and receiving the electrode assemblies 120 in an internal space thereof.

The first external case 111 may be combined with the second external case 112 to cover the plurality of electrode assemblies 110 received and mounted in the second external case 112. In such a state, edges of the first external case 111 and the second external case 112 may be thermally fused to seal the pouch 110.

The first external case 111 may include first grooves 111a formed at positions corresponding to connecting regions between the plurality of electrode assemblies 120. The first grooves 111a may be formed to extend in a second direction perpendicular to a first direction in which the electrode assemblies 120 are arranged. Each of the first grooves 111a may be formed to a predetermined depth from a surface of the first external case 111 while passing across the first external case 111 in the second direction. The first grooves 111a may be formed by reducing a thickness of one or more layers of the first external case 111 or by bending the first external case 111 at the location of the first grooves 111a. Each of the first grooves 111a may be formed to have a first width W₁. The first external case 111 may be bent to a certain extent as allowed by the first grooves 111a.

In addition, the positions of the first grooves 111a correspond to the connecting regions between the electrode assemblies 120. Accordingly, the electrode assemblies 120 may not be subjected to shocks even if the first external case 111 is bent.

The first external case 111 may have a degree of bending freedom at the positions of the first grooves 111a and may be bendable as allowed by the first grooves 111a.

The electrode assemblies 120 may be mounted in the second external case 112 in the inner space of the second external case 112. The second external case 112 may include second grooves 112a formed at positions corresponding to connecting regions between the plurality of electrode assemblies 120. Like the first grooves 111a of the first external case 111, the second grooves 112a may be formed to extend in the second direction perpendicular to the first direction in which the electrode assemblies 120 are arranged. The second grooves 112a may be formed on a surface of the second external case 112 and may be formed at positions that vertically correspond to positions of the first grooves 111a. The second grooves 112a may be formed by reducing a thickness of one or more layers of the second external case 112 or by bending the second external case 112 at the location of the second grooves 112a.

Each of the second grooves 112a may be formed to have a second width W₂. When the second width W₂ of each of the second grooves 112a is greater than the first width W₁ of each of the first grooves 111a, the second external case 112 may be easily bent toward the second grooves 112a. As illustrated in FIG. 4, the secondary battery 100 according to an embodiment may be bent toward its bottom portion where the second external case 112 is positioned. The secondary battery 100 according to an embodiment may be upwardly or downwardly bent through the first grooves 111a of the first external case 111 or the second grooves 112a of the second external case 112. Accordingly, the secondary battery 100 may be configured to be bendable according to the specification of a device in which the secondary battery 100 is mounted.

The electrode assemblies 120 may include a plurality of electrode assemblies including, for example, first to third electrode assemblies 121 to 123. The electrode assemblies 120 may be configured such that the electrode assemblies 121 to 123 are sequentially arranged and are electrically connected through the lead tabs 130. For example, the electrode assemblies 120 may be connected in parallel through the lead tabs 130. In other implementations, the electrode assemblies 120 may be connected in series or in series/parallel according to choice.

Each of the first to third electrode assemblies 121 to 123 may be configured such that a first electrode plate and a second electrode plate are wound with a separator disposed therebetween in a jelly-roll type. The first electrode plate may be a positive electrode plate and the second electrode plate may be a negative electrode plate. In other implementations, polarities of the first electrode plate and the second electrode plate may be reversed. For the sake of convenient explanation, the following description will be made with regard to a case where the first electrode plate is a positive electrode plate and the second electrode plate is a negative electrode plate.

The first electrode plate may be formed by coating a first active material, such as a transition metal oxide, as an example, onto a first electrode current collector formed of a metal foil, such as an aluminum foil, as an example. The first electrode plate may include an uncoated portion, which is a region on which the first active material is not coated. The uncoated portion may provide a path for the flow of current between the first electrode plate and the outside.

The second electrode plate may be formed by coating a second active material, such as graphite or carbon, onto a second electrode current collector formed of a metal foil, such as a copper foil or a nickel foil. The second electrode plate may include an uncoated portion, which is a region on which the second active material is not coated.

The separator may be positioned between the first electrode plate and the second electrode plate to prevent an electrical short and to allow for movement of lithium ions. The separator may be made of polyethylene, polypropylene, or a composite film of polyethylene and polypropylene, as examples.

The electrode assemblies 120 may be accommodated in the pouch 110 together with an electrolyte. The electrolyte may include an organic solvent, such as ethylene carbonate (EC), propylene carbonate (PC), diethyl carbonate (DEC), ethyl methyl carbonate (EMC), or dimethyl carbonate (DMC), and a lithium salt, such as LiPF₆ or LiBF₄, as examples.

The lead tabs 130 may be electrically connected to the electrode assemblies 120 and may protruded and be exposed to the outside of the pouch 110. The lead tabs 130 include first and second lead tabs 131 and 132 provided in pair in forms of elongated strips. The lead tabs 130 may be configured to pass through the first to third electrode assemblies 121 to 123. For example, the first and second lead tabs 131 and 132 may be integrally formed to be electrically connected to the uncoated portions of each of the first to third electrode assemblies 121 to 123, forming a positive electrode and a negative electrode. To this end, when the electrode assemblies 121 to 123 are wound, the respective lead tabs 131 and 132 may also be wound. When the first lead tab 131 is a positive electrode, the first lead tab 131 may be made of aluminum. When the second lead tab 132 is a negative electrode, the second lead tab 132 may be made of copper. However, the polarities and materials of the first and second lead tabs 131 and 132 may be altered according to the choice.

In some implementations, the first to third electrode assemblies 121 to 123 may be electrically connected in parallel.

The first lead tab 131 and the second lead tab 132 may be exposed to exterior sides of the electrode assemblies 121 to 123 between each of the electrode assemblies 121 to 123. The first grooves 111a of the first external case 111 and the second grooves 112a of the second external case may be formed at positions corresponding to the first and second lead tabs 131 and 132. The pouch 110 may be bendable at positions where only the first lead tab 131 and the second lead tab 132 having relatively small thicknesses are provided. Accordingly, damage to the electrode assemblies 120 when the pouch 110 is bent may be avoided.

Insulation members 131a and 132a may be attached to regions where the first lead tab 131 and the second lead tab 132 are coupled to the pouch 110, for example, where the first lead tab and the second lead tab exit the pouch 110. The insulation members 131a and 132a may electrically insulate the pouch 120 from the lead tabs 131 and 132 and a sealed state may be maintained even at the regions where the lead tabs 131 and 132 are formed.

As described above, the secondary battery 100 according to an embodiment may be configured to be bendable without causing damage to the electrode assemblies 121 to 123 by forming the first grooves 111a and the second grooves 112a in the first external case 111 and the second external case 112 of the pouch 110 with respect to positions where the plurality of electrode assemblies 121 to 123 are connected to each other through the lead tabs 130.

Hereinafter, a configuration of a secondary battery according to another embodiment will be described.

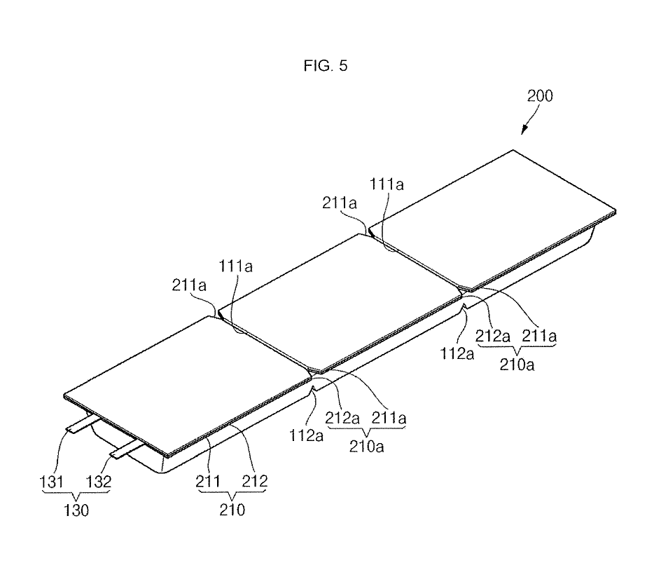

FIG. 5 illustrates a perspective view of a secondary battery according to another embodiment.

Referring to FIG. 5, the secondary battery 200 according to an embodiment includes a pouch 210, electrode assemblies (as in FIG. 2), and lead tabs 130. In FIG. 5, functional elements having the same configuration and operation are denoted by the same reference numeral and the following description will focus on differences between the present and previous embodiments. In addition, the electrode assemblies may have the same configuration as the electrode assemblies 120 of the previous embodiment, and a description thereof will not be repeated.

The pouch 210 may include a first external case 211 covering top portions of the electrode assemblies and a second external case 212 that accommodates the electrode assemblies.

The first external case 211 and the second external case 212 may be sealed by fusing edges thereof. Notches 210a may be formed at opposite edge of the first external case 211 having first grooves 111a formed therein. The notches 210a may be formed to extend in an inward direction from the edge of the first external case 211, the edge of the first external case 211 being a relatively outer side. The notches 210a may be formed at locations corresponding to the first grooves 111a. To form the notches 210a, notches 211a and 212a having the same configuration may be formed with respect to the first external case 211 and the second external case 212 to be vertically superposed. The notches 210a may reduce the areas of the fused edges of the pouch 210, thereby increasing the degree of bending freedom.

The secondary battery 200 according to this embodiment may be formed to be easily bendable by forming not only the first grooves 111a and the second grooves 112a but also the notches 210a corresponding to opposite ends of the first grooves 111a.

Hereinafter, a configuration of a secondary battery according to another embodiment will be described.

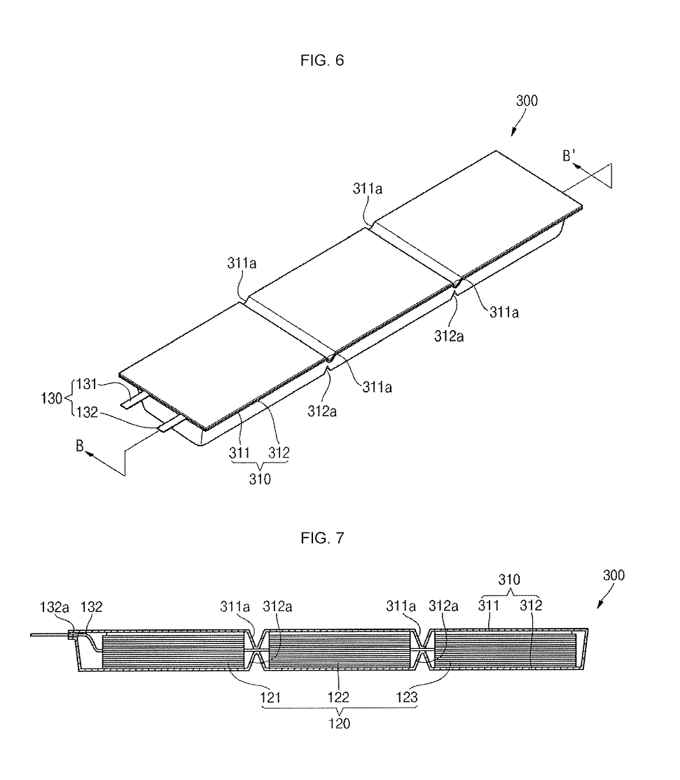

FIG. 6 illustrates a perspective view of a secondary battery according to another embodiment and FIG. 7 illustrates a cross-sectional view taken along the line B-B′ of FIG. 6.

Referring to FIGS. 6 and 7, the secondary battery 300 according to this embodiment may include a pouch 310, electrode assemblies 120, and lead tabs 130.

The pouch 310 may include a first external case 311 covering top portions of the electrode assemblies 120 and a second external case 312 that accommodates the electrode assemblies 120.

The first external case 311 and the second external case 312 may include first grooves 311a and second grooves 312a formed at regions between the electrode assemblies 121 to 123 of the electrode assemblies 120.

The first grooves 311a and the second grooves 312a may be formed to contact the lead tabs 130 connecting the electrode assemblies 121 to 123. The first grooves 311a and the second grooves 312a may be formed to have the same width and depth. The first external case 311 and the second external case 312 may be fused to each other with the lead tabs 130 disposed therebetween at regions of the first and second grooves 311a and 312a.

In the secondary battery 300 according to this embodiment, the respective assemblies 121 to 123 may be physically independent of one another but may be electrically connected in parallel by the lead tabs 130.

According to this embodiment, even if sealed portions of the secondary battery 300 were to become sufficiently damaged to cause leakage when the secondary battery 300 is bent, such leakage of an electrolyte would occur with respect to only some of the electrode assemblies 121 to 123, thereby increasing the safety of the secondary battery 300.

By way of summation and review, a pouch-type lithium secondary battery includes a pouch case generally having a multi-layered structure consisting of a metal foil layer and a synthetic resin layer covering the metal foil layer. In this case, the pouch-type lithium secondary battery has an advantage in that the weight of the battery can be noticeably reduced, compared to the cylindrical or prismatic lithium secondary battery using a metal can.

Embodiments provide a secondary battery configured to be bendable at an angle to facilitate installation in a device. The secondary battery according to an embodiment can be configured to be bendable without causing damage to electrode assemblies by including first grooves and second grooves in a first external case and a second external case of a pouch at positions at which a plurality of electrode assemblies are connected through lead tabs.

The secondary battery according to the embodiments may increase the degree of bending freedom by further including notches at opposite ends of each of the first grooves extending toward the inside of the pouch.

Further, the secondary battery according to embodiments may reduce a risk of leakage by including first grooves and second groove of sufficient depth to contact lead tabs connecting electrode assemblies to each other, while improving the degree of bending freedom.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A secondary battery, comprising:
a pouch including a first external case and a second external case;
a plurality of electrode assemblies accommodated in the pouch; and
lead tabs electrically connected to each other, the lead tabs passing through each of the plurality of electrode assemblies.

2. The secondary battery as claimed in claim 1, wherein the lead tabs are integrally formed and wound together with the plurality of electrode assemblies.

3. The secondary battery as claimed in claim 1, wherein grooves are located on a surface of one selected from the first external case and the second external case.

4. The secondary battery as claimed in claim 3, wherein the grooves are provided at positions corresponding to exposed portions of the lead tabs between the plurality of electrode assemblies.

5. The secondary battery as claimed in claim 3, wherein the grooves extend across the surface of the one selected from the first external case and the second external case in a second direction perpendicular to a first direction in which the electrode assemblies are arranged.

6. The secondary battery as claimed in claim 3, wherein one or more notches are formed at regions corresponding to opposite ends of each of the grooves, the notches extending in an inward direction.

7. The secondary battery as claimed in claim 6, wherein:
the first external case and the second external case are fused at edges of the pouch, and
the one or more notches extend horizontally in the inward direction from edges of the pouch at which the first external case and the second external case are fused.

8. The secondary battery as claimed in claim 1, wherein:
the first external case and the second external case of the pouch include first grooves and second grooves respectively provided on surfaces of the first external case and the second external case, and
the second grooves are larger than the first grooves.

9. The secondary battery as claimed in claim 8, wherein the first grooves and the second grooves protrude toward the inside of the pouch so as to contact the lead tabs.

10. The secondary battery as claimed in claim 9, wherein the first grooves and the second grooves are formed at vertically corresponding positions.
